(19) United States
(12) Patent Application Publication
(10) Pub. No.: US 2005/0219368 A1
(43) Pub. Date: Oct. 6, 2005

(54) Photography system

(75) Inventor: Takashi Kobayashi, Kanagawa-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/092,627

(22) Filed: Mar. 30, 2005

(30) Foreign Application Priority Data
Mar. 30, 2004 (JP) 098175/2004

(51) Int. Cl. H04N 5/225; H04N 5/222; G03B 17/00

(52) U.S. Cl. 348/207.11; 348/333.02

(57) ABSTRACT

Continuous photography can be realized even in the case where time necessary for image information reading becomes long at the time of photography of faint light by a photography system. A photography unit has two imaging devices for outputting image information by photography of a subject, and a photography control apparatus controls the imaging devices so that reading of the image information can be started from one of the imaging devices having finished photography of the subject while photography of the subject is started by the other imaging device at the same time.

### BACKGROUND OF THE INVENTION

1. Field of the Invention

The present invention relates to a photography system for photographing a subject placed in a casing.

2. Description of the Related Art

Photography apparatuses, for photographing a subject placed in a casing by illuminating the subject with a light source in the casing, are employed in various fields. For example, in the field of biochemistry, a fluorescence detection system using a fluorescing material as a labeling compound is known. According to the fluorescence detection system, a gene sequence, a gene manifestation level, separation and identification of a protein, and evaluation of molecular weight and characteristics of the protein can be carried out by reading a fluorescence image.

More specifically, a fluorescent dye is added to a solution including DNA fragments, and the DNA fragments are subjected to electrophoresis on a gel support. Alternatively, DNA fragments are subjected to electrophoresis on a gel support including a fluorescent dye. Thereafter, the gel support is soaked in a solution including a fluorescent dye for labeling the DNA fragments, for example. By detecting fluorescent light generated by stimulation of the fluorescent dye with a stimulating ray, an image is formed. In this manner, DNA distribution on the gel support can be detected.

Alternatively, after electrophoresis of DNA fragments on a gel support, DNA is denatured. According to Southern blotting method, at least a portion of the denatured DNA fragments is transcribed on a filter or membrane of nitrocellulose or the like. In this manner, the denatured DNA fragments are hybridized with a probe adjusted by labeling complementary DNA or RNA of target DNA with a fluorescent dye, and complementary DNA fragments to the probe DNA or the probe RNA are selectively marked. The fluorescent dye is then stimulated with a stimulating ray, and an image is formed by detecting fluorescent light generated upon exposure to the stimulating ray. In this manner, DNA distribution on the filter or membrane can be detected.

Furthermore, attention is being focused on a microarray analysis system as a biochemical analysis system. For example, in a microarray analysis system using a fluorescent material as a labeling compound, a specific bonding substance of known base sequence, base length, and composition that can specifically bond with a biogenic material such as a hormone, a tumor marker, an enzyme, an antibody, an antigen, an abzyme, another protein, nucleic acid, cDNA, DNA, and RNA is dripped on different positions of surface of a support such as a glass slide or a membrane filter with use of a spotter, and a plurality of independent spots are generated. Thereafter, a material obtained from living tissue by extraction or isolation, such as a hormone, a tumor marker, an enzyme, an antibody, an antigen, an abzyme, another protein, nucleic acid, cDNA, DNA, and mRNA, or a biogenic material having been subjected to chemical processing or chemical modification processing and marked with a fluorescent labeling compound such as a fluorescent material or a fluorescent dye is hybridized with the specific bonding substance. In this manner, a microarray is generated, and a stimulating ray is irradiated on the microarray for photoelectrically detecting fluorescent light emitted from the labeling compound such as the fluorescent dye or the like. In this manner, a biogenic material is analyzed.

In the biochemical analysis system described above, a photography apparatus having a light source for a stimulating ray and a CCD in a casing is used in order to detect fluorescent light or the like. The microarray or gel described above is placed in the casing as a specimen, and the CCD as an imaging unit detects the fluorescent light emitted from the specimen by irradiation of the stimulating ray from the light source to the specimen.

Meanwhile, there are photography apparatuses for systems including a biochemical analysis system, for photographing a subject contained in a casing with an imaging unit through irradiation of a light to the subject from a light source in the casing. In such a photography apparatus, a light source for irradiating a light (including a stimulating ray) is fixed. Since an emitted light (fluorescent light) to be detected is faint, especially in a biochemical analysis system, an imaging unit is cooled for long-time exposure. Furthermore, when image information is read from an imaging unit, the reading is carried out for a long time with a low speed in order not to be influenced by noise (see Japanese Unexamined Patent Publication No. 2003-287494).

However, if the reading of the image information from the imaging unit takes too long, subsequent photography cannot be carried out immediately after the reading. Therefore, a plurality of sets of image information cannot be obtained by continuous photography of a subject. Although exposure for subsequent photography may be carried out at the same time of image information reading from an imaging device, undesirable noise tends to occur.

### SUMMARY OF THE INVENTION

The present invention has been conceived based on consideration of the above circumstances. An object of the present invention is therefore to provide a photography system enabling continuous photography even in the case where reading of image information from an imaging device is prolonged at the time of photography of faint light.

A photography system of the present invention comprises: a casing in which a subject is contained; a photography apparatus comprising a photography unit for outputting image information by photographing the subject in the casing; and a photography control apparatus for controlling operation of the photography apparatus. The photography system of the present invention is characterized by that
the photography unit has a plurality of imaging devices for outputting the image information by respectively carrying out photography of the subject, and
the photography control apparatus controls the imaging devices so that reading of the image information is started from any one of the imaging devices having finished the photography of the subject while another one of the imaging devices starts the photography of the subject.

The subject may be a specimen emitting a light by being in contact with a chemiluminescence substrate, or a fluorescent labeling specimen labeled with a fluorescent dye that emits fluorescent light by being exposed to a stimulating ray.

The photography control apparatus may have other functions, as long as the photography control apparatus can control the imaging devices so that the image information reading can be started from the imaging device having finished photography of the subject while photography of the subject is started by another one of the imaging devices. For example, the photography control apparatus may have a function of controlling the imaging devices so that each of the imaging devices can photograph the same subject with the same exposure time.

At this time, the photography control apparatus may further comprise:
correction coefficient calculation means for calculating a correction coefficient for correcting the image information for each of the imaging devices by causing the image information from the respective imaging devices obtained by photographing the same subject with the same exposure time to become the same through comparison of the image information from the respective imaging devices; and
correction means for correcting the image information obtained by the respective imaging devices by using the correction coefficient calculated by the correction coefficient calculation means.

Causing the image information to become the same refers to causing signal values for pixels in the image information obtained by the respective imaging devices to become the same. The correction coefficient may be calculated one by one for the respective imaging devices in the photography unit. Alternatively, the correction coefficient may be calculated by using one of the imaging devices as a reference for calculation for the remaining imaging device or devices.

According to the photography system of the present invention, the photography unit has the imaging devices for outputting the image information by photography of the subject, and the photography control apparatus controls the imaging devices so that image information reading is started from any one of the imaging devices having finished photography of the subject while another one of the imaging devices starts photography of the subject. In this manner, photography can be carried out by one of the imaging devices while the image information is being read from another one of the imaging devices. Therefore, the subject can be photographed continuously even in the case where the reading of the image information of faint light is prolonged.

In the case where the photography control apparatus has the function of controlling the imaging devices so that the respective imaging devices can photograph the same subject with the same exposure time, and comprises the correction coefficient calculation means for calculating the correction coefficient for correcting the image information for each of the imaging devices by causing the image information from the imaging devices obtained by photography of the same subject with the same exposure time to become the same through comparison of the image information and correction means for correcting the image information obtained by the respective imaging devices by using the correction coefficient calculated by the correction coefficient calculation means, the image information from the respective imaging devices can be corrected in the case where sensitivity characteristics are different among the imaging devices or in the case where the intensity of light emitted from the subject changes over time, for example.

### BRIEF DESCRIPTION OF THE DRAWINGS

FIG. 1 is a perspective view of a preferred embodiment of a photography system of the present invention;

FIG. 2 is a diagram showing a photography apparatus in the photography system shown in FIG. 1;

FIG. 3 is a diagram showing a photography unit in the photography apparatus shown in FIG. 2;

FIG. 4 is a block diagram showing the configuration of the photography system of the present invention; and

FIG. 5 is a time chart showing an example of an operation of the photography unit shown in FIG. 3.

### DESCRIPTION OF THE PREFERRED EMBODIMENT

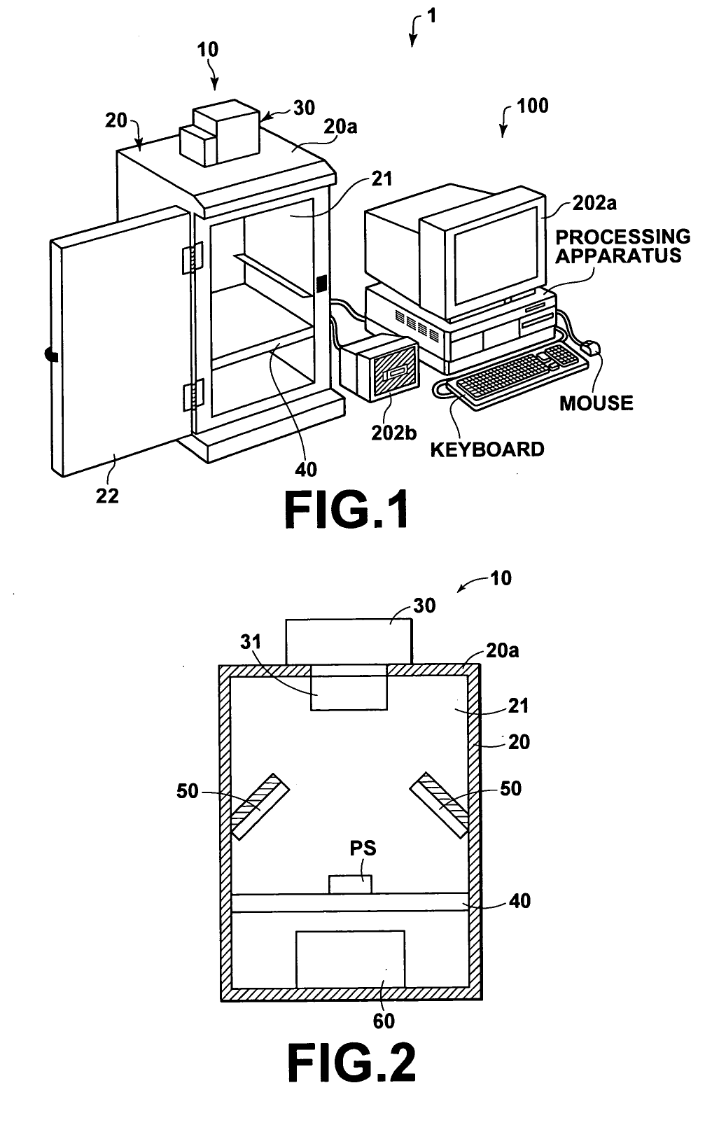

Hereinafter, an embodiment of a photography system of the present invention will be described with reference to the accompanying drawings. FIG. 1 is a perspective view of a photography system of a first embodiment of the present invention. A photography system 1 in this embodiment is a fluorescence detection system for displaying a fluorescence image by irradiating a stimulating ray to a subject such as a fluorescent material. As shown in FIG. 1, the photography system 1 comprises a photography apparatus 10 and a photography control apparatus 100. The photography apparatus 10 and the photography control apparatus 100 are placed on a desk and the photography control apparatus 100 comprises a computer, for example. The photography apparatus 10 photographs a subject PS and sends image information of the subject to the photography control apparatus 100. The photography control apparatus 100 carries out image processing on the image information, and displays the image on display units 202a and 202b. The subject may be a specimen emitting a light by being in contact with a chemiluminescence substrate (chemiluminescence method) or a fluorescent labeling specimen labeled with a fluorescent dye that emits fluorescent light by being exposed to a stimulating ray (fluorescence method).

FIG. 2 is a cross-sectional view of the photography apparatus 10 in the photography system 1 of the present invention. The photography apparatus 10 in FIG. 2 comprises a casing 20 for containing the subject PS and a photography unit 30 for outputting the image information by photographing the subject PS.

The casing 20 has a void space 21 formed in the shape close to a rectangular solid. The casing 20 has a subject placement unit 40 for placing the subject PS thereon. The casing 20 has a door 22 that can be opened and closed so that a user can place the subject PS in the casing 20 by opening the door 22. The casing 20 forms a dark box wherein a light cannot enter the void space 21 so that photography can be carried out in the case where the light emitted from the subject PS is faint.

The photography unit 30 is fixed on an upper side 20a of the casing 20, and the photography unit 30 outputs the image information by photography of the subject PS in the casing 20. A cooling unit, which is not shown in FIG. 2, is also attached to the photography unit 30 so that noise caused by a dark current can be prevented from being included in the image information by cooling the photography unit 30. The photography unit 30 has a lens unit 31, and the lens unit 31 focuses on the subject PS. Within the casing 20 are placed upper light sources 50 for emitting the stimulating ray above the subject placement unit 40 and a bottom light source 60 for emitting the stimulating ray from below the subject PS, for causing the luminescent material as the subject PS to emit the light.

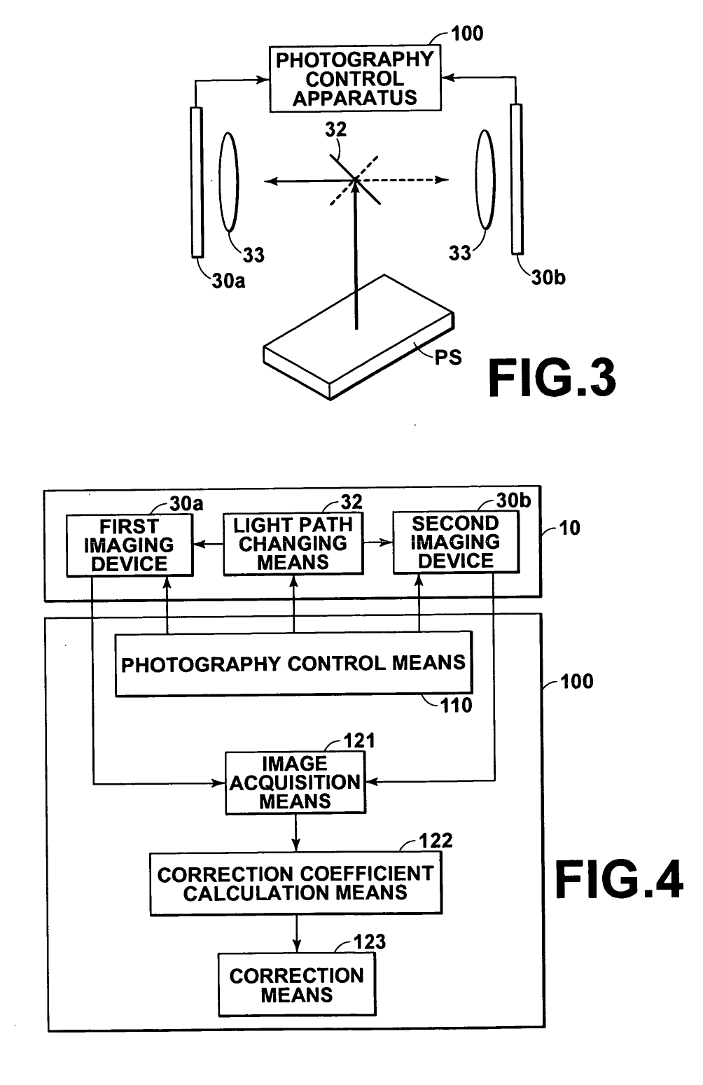

FIG. 3 shows an example of the photography unit 30. The photography unit 30 in FIG. 3 has a first imaging device 30a and a second imaging device 30b for outputting the image information by photographing the subject PS, and light path changing means 32 for changing a path of the light emitted from the subject PS to the first imaging device 30a or to the second imaging device 30b.

The imaging devices 30a and 30b comprise CCDs or the like, and sends the image information to the photography control apparatus 100 by obtaining the image information through photoelectric conversion of the light from the subject PS entering from lenses 33 via the light path changing means 32. The light path changing means 32 comprises a galvanomirror or the like having a function of adjusting an angle of the incident light from the subject PS to the imaging device 30a or 30b. In the case where the first imaging device 30a photographs the subject PS, the light path changing means 32 leads the light from the subject PS to the first imaging device 30a. In the case where the second imaging device 30a photographs the subject PS, the light path changing means 32 adjusts the angle thereof to lead the light from the subject PS to the second imaging device 30b.

FIG. 4 is a block diagram showing an example of the photography control apparatus 100. The photography control apparatus 100 in FIG. 4 has photography control means 110 for controlling the imaging devices 30a and 30b so that reading of the image information can be started from the first imaging device 30a (or the second imaging device 30b) having finished photography of the subject PS while photography of the subject PS is started by the second imaging device 30b (or the first imaging device 30a) at the same time.

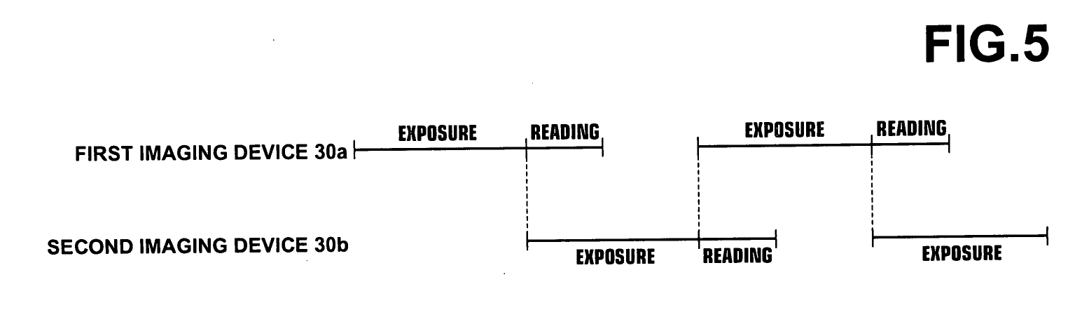

More specifically, the photography control means 110 controls the imaging devices 30a and 30b as well as the angle of the light path changing means 32. As shown in FIG. 5, the photography control means 110 causes the second imaging device 30b to start exposure (photography) by adjusting the angle of the light path changing means 32 for causing the light from the subject PS to enter the second imaging device 30b at the same time the image information reading is started from the first imaging device 30a after exposure (photography) by the first imaging device 30a. Likewise, the photography control means 32 causes the first imaging device 30a to start exposure (photography) by adjusting the angle of the light path changing means 32 for causing the light from the subject PS to enter the first imaging device 30a at the same time the image information reading is started from the second imaging device 30b after exposure (photography) by the second imaging device 30b. In this manner, even in the case where the image information is being read from the first imaging device 30a (or the second imaging device 30b), the second imaging device 30b (or the first imaging device 30a) can carry out photography. Therefore, the subject can be photographed continuously even in the case where the time necessary for the reading of the image information becomes long as in the case of photography of the faint light.

Furthermore, the photography control apparatus 100 has a function of correcting the image information in addition to controlling operation of the photography apparatus 10. More specifically, the photography control apparatus 100 has image acquisition means 121 for obtaining image information sets in the case where the imaging devices 30a and 30b respectively photograph the same subject with the same exposure time, correction coefficient calculation means 122 for calculating a correction coefficient for each of the imaging devices 30a and 30b for correcting the image information sets in order to cause the image information sets to become the same through comparison of the image information sets obtained by the image acquisition means 121, and correction means 123 for correcting the image information sets obtained by the respective imaging devices 30a and 30b according to the correction coefficient calculated by the correction coefficient calculation means 122. The photography control means 110 in this case has a function of controlling the imaging devices 30a and 30b for causing the imaging devices to photograph the same subject with the same exposure time.

More specifically, in the image acquisition means 121, two sets of the image information are obtained by the imaging devices 30a and 30b through photography of the same subject PS with the same exposure time. At this time, the two image information sets are supposed to be the same. However, in the case where sensitivity is different between the first imaging device 30a and the second imaging device 30b, the two image information sets are not the same. In other words, signal values of corresponding pixels in the two image information sets obtained by the imaging devices 30a and 30b are not the same. If the image information sets output from the imaging devices 30a and 30b are not the same, accurate image analysis cannot be carried out.

For this reason, the correction coefficient calculation means 122 compares the two image information sets obtained by the imaging devices 30a and 30b, and detects pixels having the different values in the two image information sets. The correction coefficient calculation means 122 then calculates the correction coefficient for causing the image information set from the second imaging device 30b (hereinafter referred to as the second image information set) to become the same as the image information sets from the first imaging device 30a (hereinafter referred to as the first image information set), by using the first image information set as a reference, for example. More specifically, a ratio of the signal value in the first image information set to the signal value in the second image information set is calculated at the same pixel in the first and second image information sets.

Thereafter, the correction means 123 corrects the second image information set by using the correction coefficient found by the correction coefficient calculation means 122. In this manner, even in the case where a characteristic is different between the imaging devices 30a and 30b, accurate image analysis can be carried out by absorbing the characteristic difference through correction of the image information sets based on the correction coefficient.

According to the embodiment described above, the photography unit 30 has the imaging devices 30a and 30b for outputting the image information by photography of the subject PS, and the photography control apparatus 100 has the photography control means 110 for controlling the imaging devices 30a and 30b so that reading of the image information can be started from the first imaging device 30a (or the second imaging device 30b) having finished photography of the subject PS while photography of the subject PS is started by the second imaging device 30b (or the first imaging device 30a) at the same time. In this manner, photography can be carried out by one of the imaging devices while image information reading is being carried out from the other imaging device. Consequently, the subject can be photographed continuously even in the case where the time necessary for the reading of the image information becomes long as in the case of photography of the faint light.

Furthermore, if the photography control means 110 has the function of controlling the imaging devices for causing the respective imaging devices to photograph the same subject with the same exposure time, and if the photography control apparatus 100 has the image acquisition means 121 for obtaining the image information sets in the case where the imaging devices 30a and 30b respectively photograph the same subject with the same exposure time and the correction coefficient calculation means 122 for calculating the correction coefficient for correcting the image information sets for each of the pixels in the imaging devices 30a and 30b through comparison of the image information sets obtained by the image acquisition means 121, as well as the correction means 123 for correcting the image information sets by using the correction coefficient calculated by the correction coefficient calculation means 122, the sensitivity correction can be carried out for the image information sets obtained by the imaging devices 30a and 30b.

The present invention is not necessarily limited to the embodiment described above. For example, the two imaging devices are used in FIGS. 3 and 4. However, the present invention can be applied to the case where the number of imaging devices is 3 or more. In FIG. 4, the first image information set obtained by the first imaging device 30a is used as the reference. However, the correction coefficient can be calculated for correcting the first image information set by using the second image information set obtained by the second imaging device 30b as the reference.

In FIG. 3, the galvanomirror having the angle adjustment function is used as the light path changing means 32. However, light splitting means may be used instead of the galvanomirror or the like, for causing the light from the subject PS to enter the respective imaging devices 30a and 30b by splitting the light.

1. A photography system comprising: a casing in which a subject is contained; a photography apparatus comprising a photography unit for outputting image information by photographing the subject in the casing; and a photography control apparatus for controlling operation of the photography unit, wherein
the photography unit has a plurality of imaging devices for outputting the image information by respectively photographing the subject, and
the photography control apparatus controls the imaging devices so that reading of the image information is started from any one of the imaging devices having photographed the subject while another one of the imaging devices starts to photograph the subject.

2. The photography system according to claim 1, the photography control apparatus having a function of controlling the imaging devices so that each of the imaging devices can photograph the same subject with the same exposure time, and the photography control apparatus further comprising:
correction coefficient calculation means for calculating a correction coefficient for correcting the image information for each of the imaging devices by causing the image information from the respective imaging devices obtained by photographing the same subject with the same exposure time to become the same through comparison of the image information from the respective imaging devices; and
correction means for correcting the image information obtained by the respective imaging devices by using the correction coefficient calculated by the correction coefficient calculation means.
